(19) United States
(12) Patent Application Publication
(10) Pub. No.: US 2024/0367384 A1
(43) Pub. Date: Nov. 7, 2024

(54) REGIONAL ADDITIVE MANUFACTURING THERMAL SENSORS

(71) Applicant: HEWLETT-PACKARD DEVELOPMENT COMPANY, L.P., Spring, TX (US)

(72) Inventor: Krzysztof NAUKA, Palo Alto, CA (US)

(73) Assignee: HEWLETT-PACKARD DEVELOPMENT COMPANY, L.P., Spring, TX (US)

(21) Appl. No.: 18/686,070

(22) PCT Filed: Aug. 23, 2021
(86) PCT No.: PCT/US2021/047065

§ 371 Date: Feb. 23, 2024

(51) Int. Cl. B29C 64/393; B22F 10/14; B22F 10/36; B22F 12/90; B28B 1/00; B28B 17/00; B29C 64/165; B29C 64/209; B29C 64/295; B29K 21/00; B29K 71/00; B29K 77/00; B29K 105/08; B29K 307/04; B33Y 10/00; B33Y 30/00; B33Y 50/02

(52) U.S. Cl. CPC B29C 64/393; B22F 10/14; B22F 10/36; B22F 12/90; B28B 1/001; B28B 17/0081; B29C 64/165; B29C 64/209; B29C 64/295; B33Y 10/00; B33Y 30/00; B33Y 50/02; B29K 2021/003; B29K 2071/00; B29K 2077/00; B29K 2105/08; B29K 2307/04

(57) ABSTRACT

In one example in accordance with the present disclosure, an additive manufacturing system is described. The additive manufacturing system includes an agent distribution device to selectively deposit an agent onto a layer of build material to form a layer of a three-dimensional (3D) object. The additive manufacturing system also includes a carriage to transport the agent distribution device across the layer of build material. The additive manufacturing system also includes an array of build material thermal sensors disposed on the carriage and facing the layer of build material. Each build material thermal sensor is to measure a temperature of the layer of build material in a particular region. A controller adjusts additive manufacturing based on an output of an associated build material thermal sensor.

### BACKGROUND

Additive manufacturing devices produce three-dimensional (3D) objects by building up layers of material. Some additive manufacturing devices may be referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system with regional adjustments, according to an example of the principles described herein.

FIG. 2 is a diagram of an additive manufacturing system with regional adjustments, according to an example of the principles described herein.

FIG. 3 is a diagram of an additive manufacturing system with regional adjustments, according to an example of the principles described herein.

FIG. 4 is a diagram of an additive manufacturing system with regional adjustments, according to an example of the principles described herein.

FIG. 5 is a diagram of an additive manufacturing system with regional adjustments, according to an example of the principles described herein.

FIGS. 6A and 6B are diagrams of an optical filter over a thermal sensor that faces the build material, according to an example of the principles described herein.

FIG. 7 is a graph depicting a sensor window of an optical filter, according to an example of the principles described herein.

FIG. 8 is a flow chart of a method for regionally adjusting additive manufacturing, according to an example of the principles described herein.

FIG. 9 depicts a non-transitory machine-readable storage medium for regionally adjusting additive manufacturing, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided drafting (CAD) computer program product. The model data is processed into slices, each slice defining portions of a layer of build material that are to be solidified.

In one example, to form the 3D object, a build material, which may be powder, is deposited on a bed. A fusing agent is then dispensed onto portions of a layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, visible light, ultraviolet light, laser light, or other suitable electromagnetic radiation. Due to the increased heat absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption characteristics, fuses into a solid object while that portion of the build material that has not received the fusing agent remains in powder form. Those portions of the build material that receive the agent and thus have increased heat absorption properties may be referred to as fused portions. By comparison, the applied heat is not so great so as to increase the heat of the portions of the build material that are free of the agent to this fusing temperature. Those portions of the build material that do not receive the agent and thus do not have increased heat absorption properties may be referred to as unfused portions.

Accordingly, a predetermined amount of heat is applied to an entire bed of build material, the portions of the build material that receive the fusing agent, due to the increased heat absorption properties imparted by the fusing agent, fuse and form the object while the unfused portions of the build material are unaffected, i.e., not fused, in the presence of such application of thermal energy. This process is repeated per layer to generate a 3D object. The unfused portions of material can then be separated from the fused portions, and the unfused portions recycled for subsequent 3D formation operations.

In another particular example, a powder build material is deposited and a binding agent is selectively applied to the layer of powder build material. The binding agent is deposited in a pattern of a slice of a 3D object to be printed. This process is repeated per layer until the 3D object is formed.

With a 3D object formed, the binding agent is cured to form a “green” 3D object. Cured binding agent holds the build material of the green object together. When activated or cured, the binding component glues the powder build material particles into the cured green object shape. The cured green object has enough mechanical strength such that it is able to withstand extraction from the build material platform without being deleteriously affected (e.g., the shape is not lost). This process is repeated per layer fashion to generate a green 3D object.

The green 3D object may then be placed in an oven to expose the green 3D object to electromagnetic radiation and/or heat to sinter the build material in the green 3D object to form the finished 3D object. Specifically, the binding agent is removed and the temperature is further raised such that sintering of the powder metal particles occurs to form a 3D object.

In some examples, such as when the build material is a metal powder material, such sintering temperatures may range between about 900 degrees Celsius to about 1700 degrees Celsius. It is to be understood that the term “green” does not connote color, but rather indicates that the part is not yet fully processed. Such a binding-agent-based system may be used to generate metallic or ceramic 3d objects.

While such additive manufacturing operations have greatly expanded manufacturing and development possibilities, further development may make 3D printing applicable in even more industries. For example, in fusing agent based additive manufacturing operations, the additive manufacturing process relies on melting the polymer powder via the enhanced light absorption properties imparted by the fusing agent. In an example, near-infrared (tungsten halogen) lamp(s) mounted on a carriage travelling above the powder surface and other lamps mounted stationarily above the carriage are used as light sources to selectively melt the polymer powder. Stable, predictable, and reproducible temperatures within the zone where powder melting occurs ensures reliable, consistent, and strong 3D printing. That is, if the layer of build material, or a portion thereof, with agent deposited thereon is insufficiently or non-uniformly heated, the resulting 3D object may have reduced physical properties such as strength and durability in associated regions.

Accordingly, the present specification provides a feedback loop that includes thermal sensors to maintain a desired thermal profile of the powder. That is, based on the output of the thermal sensors, the operation of the light sources and agent deposition device may be adjusted to ensure a desired and uniform thermal profile across the layer and across all layers of the 3D object. Specifically, the present specification describes a high-resolution adjustment of additive manufacturing to accomplish the aforementioned target thermal profiles. For example, the thermal sensors may be associated with a region, which region is defined as an area for which a thermal sensor can collect temperature measurements. Adjustments to the additive manufacturing may therefore be region based. That is, rather than adjusting an additive manufacturing property for an entire layer of build material, the present system can adjust the additive manufacturing property differently per region.

Moreover, in some cases, the mobile carriage on which an agent distribution device is mounted may block the powder bed from a thermal sensor. That is, the carriage may cast a shadow over the build material as it passes over. As such, any output from a thermal sensor may not account for the time when newly melted powder solidifies and interacts with cold, sprayed agent as during this moment in time, the carriage is blocking the thermal sensor. This gap in temperature information and lack of ability to instantaneously react to rapidly changing thermal conditions may negatively impact the quality of a 3D object, especially when printing more complex objects where changing geometry of subsequently fused regions can affect the heat flow.

Accordingly, the present specification describes an additive manufacturing system that has temperature sensors embedded into a carriage that moves across the build material. The sensors may be mounted close to the area where powder has recently been melted by the heating system and is undergoing solidification. As such, the build material thermal sensors that are facing the build material are receiving continuous and accurate measurements of the temperature across the surface of the bed and are not blocked by the carriage. Based on the output of these sensors, operation of the heating system and/or agent distribution device may be adjusted to ensure a desired, and/or uniform temperature profile of the build material so that reliable and reproducible temperatures are found across the surface of the build material.

Specifically, the present specification describes an additive manufacturing system. The additive manufacturing system includes an agent distribution device to selectively deposit an agent onto a layer of build material to form a layer of a 3D object and a carriage to transport the agent distribution device across the layer of build material. The additive manufacturing system also includes an array of build material thermal sensors disposed on the carriage and facing the layer of build material. Each build material thermal sensor is to measure a temperature of the layer of build material in a particular region. The additive manufacturing system also includes a controller of the additive manufacturing system adjusts additive manufacturing based on an output of an associated build material thermal sensor.

The present specification also describes a method. According to the method, a stationary overhead heater and a carriage heater of an additive manufacturing system are activated as a carriage passes over a first layer of powder build material to selectively solidify portions of the first layer of powder build material. While forming this first layer, a controller receives a temperature reading from an array of build material thermal sensors disposed on the carriage and facing the layer of powder build material. As described above, each build material thermal sensor measures a temperature of the layer of build material in a particular region. While forming a second layer of the 3D object, the controller adjusts additive manufacturing in different regions based on an output of an associated build material thermal sensor.

The present specification also describes a non-transitory machine-readable storage medium encoded with instructions executable by a processor. The machine-readable storage medium includes instructions to receive a temperature reading from each of an array of build material thermal sensors disposed on a carriage of an additive manufacturing system. As described above, each build material thermal sensor faces a layer of powder build material and is to measure a temperature of the layer of powder build material in a particular region. The instructions are executable by the processor, to cause the processor to generate a thermal map across a surface of the layer of powder build material and adjust additive manufacturing in different regions based on an output of an associated build material thermal sensor.

Such systems and methods 1) print 3D objects with uniform and desired mechanical properties; 2) ensure accurate, consistent, and correct temperature measurements; and 3) provide temperature readings continuously through the additive manufacturing process. However, it is contemplated that the systems and methods disclosed herein may address other matters and deficiencies in a number of technical areas.

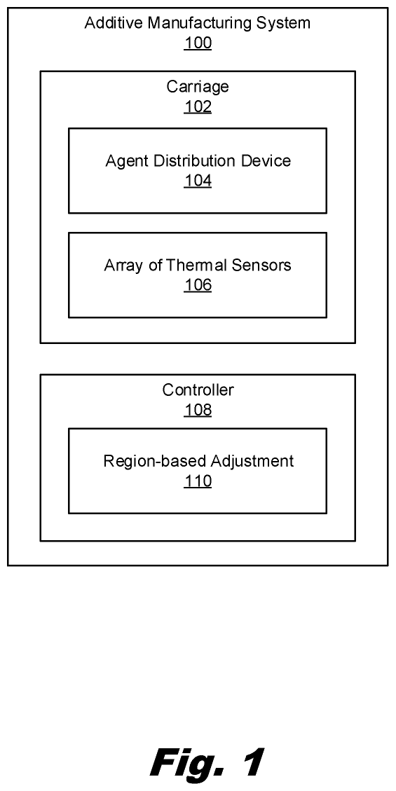

Turning now to the figures, FIG. 1 is a block diagram of an additive manufacturing system (100) with regional adjustments, according to an example of the principles described herein.

The additive manufacturing system (100) includes an agent distribution device (104) to selectively deposit an agent on to a layer of build material to form a layer of a 3D object. As described above, a 3D object is printed by hardening layers or slices of the 3D object. That is, within a build area, portions of the powder are to be fused together. The fused portions form a layer, or slice, of a 3D object. The agent distribution device (104) facilitates this solidifying by depositing at least one agent onto a layer of powdered build material. The agent, whether it be a fusing agent or a binding agent, may change the properties of the build material such that the build material may form a layer of a 3D object.

The agent distribution device (104) may distribute a variety of agents. In one specific example, the agent is a fusing agent which increases the energy absorption of portions of the build material that receive the fusing agent to selectively solidify portions of a layer of powdered build material. Another example of a deposited agent is a binding agent which glues metallic build material particles together. Other examples of agents that may be deposited include a detailing agent which cools the build material.

In some examples, the agent distribution device (104) includes at least one liquid ejection device to distribute the agents onto the layers of build material. A liquid ejection device may include at least one printhead (e.g., a thermal ejection based printhead, a piezoelectric ejection based printhead, etc.). In one example, printheads that are used in inkjet printing devices may be used in the agent distribution device (104). In this example, the fusing agent may be a printing liquid. In other examples, an agent distribution device (104) may include other types of liquid ejection devices that selectively eject small volumes of liquid.

The agent distribution device (104) may be coupled to a carriage (102) which transports the agent distribution device (104) across the layer of build material. That is, the build material may reside in a bed. A scanning carriage (102) may pass over the bed such that the agent may be deposited thereon.

The additive manufacturing system (100) may also include an array (106) of build material thermal sensors that is also disposed on the carriage (102). The array (106) of build material thermal sensors includes multiple thermal sensors on an underside that faces the layer of build material. Each build material thermal sensor of the array (106) measures a temperature of the layer of build material in a particular region. As described above, the temperature of the build material, both before and after agent deposition, may affect the resulting 3D object. If the build material is below a threshold temperature before agent deposition, then the energy of the heating system may be unable to provide sufficient energy to raise the temperature to fuse the build material. As another example, if the build material is above a threshold temperature following deposition of an agent, subsequently deposited layers of build material may inadvertently and prematurely fuse due to thermal bleed from an underlying layer and/or the part may curl or otherwise alter based on thermal stresses induced by the high temperature.

Accordingly, the array (106) of build material thermal sensors being deposited on an underside of the carriage (102) provides accurate and consistent temperature readings. That is, were the build material thermal sensors of the array (106) disposed above the carriage (102), movement of the carriage over the build material may either 1) block the radiative path from the build material to the build material thermal sensor and/or 2) reduce the temperature of the build material due to a shadow cast by the carriage (102). In either case, the output of the build material thermal sensors may be less effective in indicating an actual temperature of the build layer. These incorrect temperature values may impact the ability of the additive manufacturing system (100) to generate quality 3D objects.

Each build material thermal sensor of the array (106) is to measure a temperature of the layer of build material in a particular region. That is each build material thermal sensor has an area for which it can detect and output a temperature measurement. Other additive manufacturing components may also be associated with a region. The output of each build material thermal sensor may be mapped to a particular region, such that additive manufacturing components that are associated with a same region may be adjusted based on a temperature measurement for that region. That is, rather than applying adjustments (110) to an entire layer of build material, the present additive manufacturing system (100) may apply adjustments (110) per region of a single layer. As such, a higher resolution control over additive manufacturing is provided as regional thermal sensor outputs are used to control regional additive manufacturing.

Examples of build material thermal sensors that may be found in the array (106) include photovoltaic sensors, photoelectric sensors, bolometers, thermopiles, or pyroelectric sensors. While particular reference is made to a few build material thermal sensors, the array (106) may include other types of build material thermal sensors. In an example, build material thermal sensors may be selected based on their peak sensitivity matching the maximum thermal radiation of the heated build material.

The additive manufacturing system (100) may also include a controller (108). The controller (108) adjusts additive manufacturing in different regions based on an output of an associated build material thermal sensor. Examples of adjustments (110) that may be made include quantity of deposited fusing agent, quantity of deposited detailing agent, quantity of deposited binding agent, and radiation intensity.

For example, if a build material thermal sensor indicates that the build material in an associated region is hotter than a threshold temperature, the controller (108) may reduce the radiative intensity of the heating system, decrease the amount of fusing agent deposited, or increase the amount of detailing agent deposited in that region. In another example, responsive to a build material thermal sensor indicating that the build material in an associated region is not reaching a temperature sufficient to fuse, the controller (108) may increase the radiative intensity of the heating system, increase the amount of fusing agent deposited, or decrease the amount of detailing agent deposited in that region. Note that as described above, such adjustments (110) may be per region. That is, the adjustments (110) for one region may differ than adjustments (110) made to another region.

In some examples, such adjustments (110) may be made per layer of build material. That is, the array (106) of build material thermal sensors, during formation of a first layer of the 3D object, may take temperature readings of the first layer. Still during the first layer formation, the controller (108) may determine adjustments (110) to be made. During deposition of the second layer, the controller (108) may adjust the operation of the heating system and/or agent distribution device (104) to ensure a desired operation. As such, the present specification describes an additive manufacturing system (100) that provides real-time control of additive manufacturing so as to ensure proper fusing of each region without over-fusing the layer.

The controller (108) may include various hardware components, which may include a processor and memory. The processor may include the hardware architecture to retrieve executable code from the memory and execute the executable code. As specific examples, the controller (108) as described herein may include a computer readable storage medium, a computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (108), cause the controller (108) to implement at least the functionality of altering a heating system based on carriage-mounted thermal sensor output.

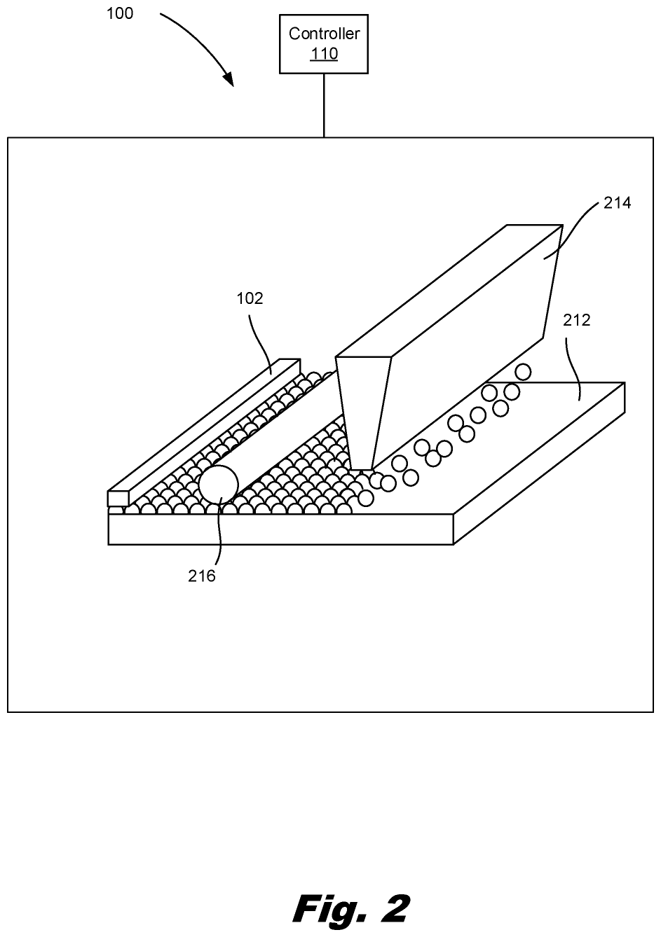

FIG. 2 is a diagram of an additive manufacturing system (100) with regional adjustments, according to an example of the principles described herein. Components of the additive manufacturing system (100) depicted in FIG. 2 may not be drawn to scale and thus, the additive manufacturing system (100) may have a different size and/or configuration other than as shown therein.

In an example of an additive manufacturing process, a layer of build material may be deposited onto a build area of a bed (212). As used in the present specification and in the appended claims, the term “build area” refers to an area of space wherein the 3D object is formed. The build area may be defined as a three-dimensional space in which the additive manufacturing system (100) can fabricate, produce, or otherwise generate a 3D object. That is, the build area may occupy a three-dimensional space on top of the bed (212) surface. In one example, the width and length of the build area can be the width and the length of bed (212) and the height of the build area can be the extent to which bed (212) can be moved in the z direction. That is, although not shown, an actuator, such as a piston, can control the vertical position of bed (212). That is, in some examples, the bed (212) may be moved up and down, e.g., along the z-axis, so that powder build material may be delivered to the bed (212) or to a previously formed layer of powder build material. For each subsequent layer of powder build material to be delivered, the bed (212) may be lowered so that the build material distributor (214) and re-distributor (216) can operate to place additional powder build material particles onto the bed (212). The bed (212) may accommodate any number of layers of metal powder build material. For example, the bed (212) may accommodate up to 4,000 layers or more.

The additive manufacturing system may include a build material distributor (214). The build material distributor (214) is arranged to dispense a build material layer-by-layer onto the bed (212) to additively form the 3D object. This powder build material may be the raw material from which a 3D object is formed. The powder build material may be of a variety of types. For example, the build material may be a metal material, such as a metal powder. The metal powder build material may include metallic particles such as steel, bronze, titanium, aluminum, nickel, cobalt, iron, nickel cobalt, gold, silver, platinum, copper and alloys of the aforementioned metals. While several examples of metals are mentioned, other build materials may be used in accordance with the principles discussed herein. For example, the build material may be a ceramic material, a crystal material, quartz, alumina, glass, and the like. In some examples, the build material may comprise a polymer material. For example, the polymer material may be a polyamide material. While specific reference is made to a polyamide material, the polymer material may be of other types including nylon, thermoplastic materials, resin, carbon-fiber enhanced resin, polyetheretherketone (PEEK), and the like.

In some examples, the build material distributor (214) may be coupled to a scanning carriage. In operation, the build material distributor (214) places build material in the bed (212) as the scanning carriage moves over the bed (212) along the scanning axis. While FIG. 2 depicts a particular build material distributor (214), the build material distributor (214) may include a variety of devices such as a sieve or rotating slotted rod to roughly dispense the build material. In some examples, the build material distributor (214) has a length at least as long as a length of the bed (214), such that the build material distributor (214) can coat the entire bed (212) with a layer of build material in a single pass.

A re-distributor (216) or other mechanism may precisely redistribute (or recoat) the deposited powder build material into a layer of a desired thickness. While FIG. 2 depicts a particular example of a re-distributor (216), other examples of a mechanism to redistribute (or recoat) the deposited powder build material may be implemented via a variety of electromechanical or mechanical mechanisms, such as a doctor blade, a roller, and an ultrasonic blade to form a coating of the build material in a generally uniform layer relative to the bed (212) or relative to a previously deposited layer of build material.

FIG. 2 also clearly depicts the carriage (102) to which the agent distribution device (FIG. 1, 104) and the array (FIG. 1, 106) of build material thermal sensors may be coupled. While the carriage (102) is moving, printheads of the agent distribution device (FIG. 1, 104) may be activated to eject an agent on the powder build material.

As depicted in FIG. 2, by placing the array (FIG. 1, 106) of build material thermal sensors on an underside of the carriage (102), there is a clear optical path between the thermal sensors and the powder build material on the bed (212) such that an accurate measurement is collected for heating system (FIG. 1, 108) adjustment.

Each of the previously described physical elements may be operatively connected to a controller (108) which controls the additive manufacturing. Specifically, in an agent-based system, the controller (108) may direct a build material distributor (214) and any associated scanning carriages to move to add a layer of powder build material. Further, the controller (108) may send instructions to direct a printhead of an agent distribution device (FIG. 1, 104) to selectively deposit the agent(s) onto the surface of a layer of the build material. The controller (108) may also direct the printhead to eject the agent(s) at specific locations to form a 3D printed object slice.

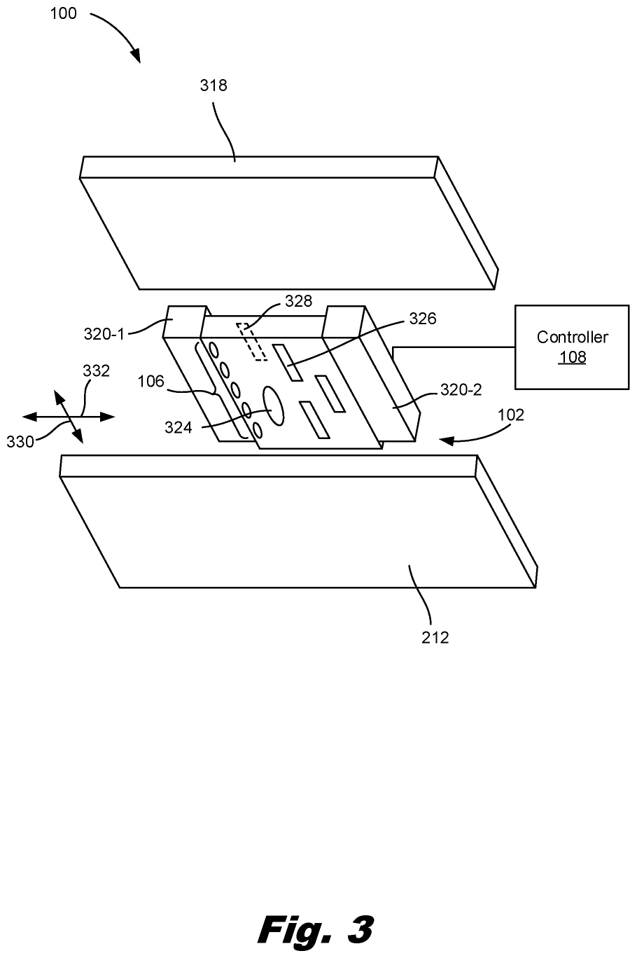

FIG. 3 is a diagram of an additive manufacturing system (100) with regional adjustments, according to an example of the principles described herein. Components of the additive manufacturing system (100) depicted in FIG. 3 may not be drawn to scale and thus, the additive manufacturing system (100) may have a different size and/or configuration other than as shown therein.

FIG. 3 clearly depicts the bed (212) on which the build material and the agent are deposited. FIG. 3 also depicts the carriage (102) to which the agent distribution device (FIG. 1, 104) is coupled. Specifically, FIG. 3 depicts the printheads (326) that make up the agent distribution device (FIG. 1, 104) and that deposit the agent. For simplicity, a single instance of a printhead (326) is indicated with a reference number.

FIG. 3 also depicts the array (106) of build material thermal sensors that enables a 2D temperature mapping rather than a single point measurement. That is, at any point in time, each of the build material thermal sensors may record a temperature reading. As such, a series of measurements along a line indicated by the arrow (330) may be recorded at an instant in time. As the scanning carriage (102) moves in a direction indicated by the arrow (332), each build material thermal sensor may take additional measurements, such that a thermal map is generated with temperatures across the entire bed (212). The location and number of build material thermal sensors may determine the spatial resolution of the measured thermal map.

As described above, each individual build material I thermal sensor may trigger a corresponding adjustment to the operation of the additive manufacturing system (100). For example, if a build material thermal sensor at one edge of the bed (212) detects that the temperature is greater than a threshold temperature, while build material a thermal sensor at a second edge detects that the temperature is within a desired and acceptable range, the controller (108) may adjust the operation of respective electromagnetic radiation heaters (320) and or the agent deposition device (FIG. 1, 104) adjacent the first edge build material thermal sensor to reduce the temperature of the build material in that region. As such, the additive manufacturing system (100) of the present specification provides for localized adjustment to additive manufacturing both in a first direction indicated by the arrow (332) and a second direction indicated by the arrow (330). Moreover, such adjustments may be done per layer such that high-resolution adjustments to the heating system and/or the agent distribution device (FIG. 1, 104) may be made on a per-layer basis such that any detected defects in heating may be quickly accounted for in a subsequent layer. Doing so may preserve a part that would otherwise be discarded. That is, if adjustments were made per layer, i.e., not localized per region, and were not made until after the part were complete, i.e., not between layers, then any remedial measure may render the entire 3D object defective. As such, the present additive manufacturing system (100) provides for quick and effective remediation of undesirable or irregular thermal characteristics.

FIG. 3 also depicts a heating system to selectively heat the layer of powder build material. That is, the energy from the heating system heats the powder build material in the bed. That powder build material with fusing agent disposed thereon absorbs enough energy, such that the underlying powder build material particles fuse together to form the slice of the 3D printed object.

In this example, the heating system includes a carriage heater (320-1, 320-2) to selectively solidify portions of the layer of powder build material with fusing agent deposited thereon and a stationary overhead heater (318) to maintain the layer of powder build material at a predetermined temperature below a fusing temperature of the fusing agent. That is, the fusing temperature refers to the temperature at which the fusing agent causes the build material particles to fuse together. Energy is consumed to raise the temperature past this fusing temperature. The greater the difference between the environmental temperature and the fusing temperature, the greater the energy to raise the temperature of the build material. Accordingly, the stationary overhead heater (318) maintains the temperature at a level just below this fusing temperature so as to reduce the energy to raise the material to the fusing temperature.

Moreover, temperature drops that are too rapid may induce thermal stresses on the 3D object, which could cause the 3D object to curl. Accordingly, the stationary overhead heater (318) may prevent the fused build material from cooling too quickly, which may negatively impact the 3D object properties.

Each of these heaters may have a number of heating elements. For example, the carriage heaters (320) may each have a number of heating elements, which may be associated with regions. As such, the controller (108) may adjust individual heating elements of the heating system based on an output of a build material thermal sensor in an associated region. For example, a build material thermal sensor that determines a temperature on a left edge of the width of the carriage (102) may indicate that the temperature in this left edge region is greater than a predetermined threshold. Accordingly, the controller (108) may instruct the individual heating element in the same left edge region to emit at a reduce intensity. At the same time, the controller (108) may instruct other heating elements to operate differently (i.e., reduce by different amounts, increase intensity, or maintain intensity). As such, the present additive manufacturing system (100) provides for customized and localized control over components that facilitate additive manufacturing.

In addition to those components mentioned, the additive manufacturing system (100) may include additional components. For example, the additive manufacturing system (100) may include a carriage thermal sensor (324) embedded in the carriage (102) to sense a carriage temperature. In some examples, the carriage thermal sensor (324) may provide a baseline for accurate reading of the build material thermal sensors. In this example, the controller (108) may account for the temperature measurements from the carriage thermal sensor (324) in determining an actual temperature of the build material and in determining what adjustments are to be made to the heaters (318, 320) and printheads (326). For example, as the carriage (102) is facing the build material which is heating up, the carriage (102) itself may become hot, for example above 100 degrees Celsius, and may irradiate towards the build material thermal sensors. In this example, the controller (108) may subtract the output of the carriage thermal sensor (324) from the output of the build material thermal sensors (322) such that an accurate indication is made of the build material temperature. That is, the temperature measurements of the build material thermal sensors are offset by a temperature measurement of the carriage thermal sensor (324).

As another example, the additive manufacturing system (100) may include a cooling system (328) to prevent overheating of the build material thermal sensors in the array (106). That is, as described above, the temperature between the carriage (102) and the bed (212) may be rise above 100 degrees Celsius. While build material thermal sensors may be capable of operating in this temperature range, the life of the build material thermal sensor may be prolonged when a cooling system (328) is implemented to cool the build material thermal sensors of the thermal sensing system (FIG. 1, 106). In addition, a build material thermal sensor output may be more accurate when the build material thermal sensor is maintained at a constant temperature. In examples where the additive manufacturing system (100) includes a cooling system (328), the carriage thermal sensor (324) may be removed.

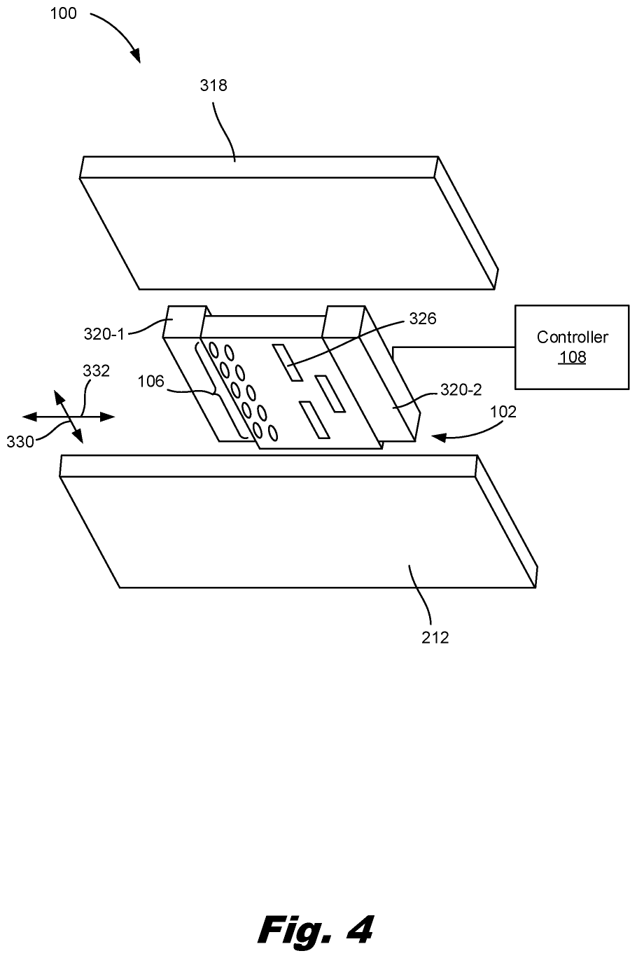

FIG. 4 is a diagram of an additive manufacturing system (100) with regional adjustments, according to an example of the principles described herein. In the example depicted in FIG. 4, the array (106) includes a greater number of build material thermal sensors then the array (106) depicted in FIG. 3. As such, an even higher resolution of the temperature measurements may be made such that even greater localized responses, i.e., heating system adjustment and/or additive manufacturing adjustment, may be made. Such an arrangement may provide temperature mapping when the build material thermal sensors are slower, i.e., take a longer time to capture a temperature signal, and the carriage (102) is moving quickly. That is, the second row of build material thermal sensors may kick in when build material thermal sensors of the first row are actively receiving a temperature reading.

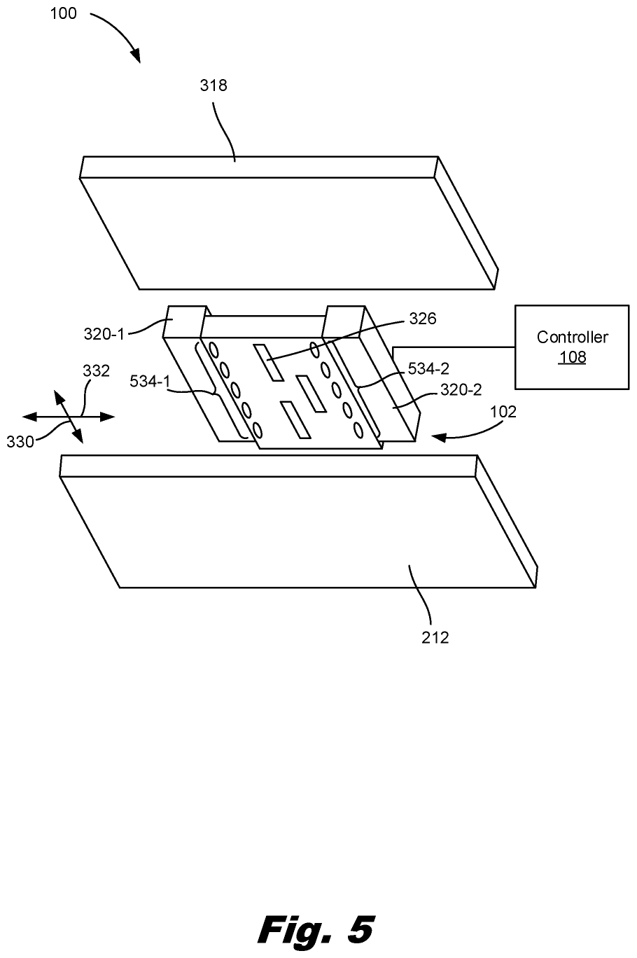

FIG. 5 is a diagram of an additive manufacturing system (100) with regional adjustments, according to an example of the principles described herein. In the example depicted in FIG. 5, the array (FIG. 1, 106) of build material thermal sensors is divided into a first sub-array (534-1) and a second sub-array (534-2). A first sub-array (534-1) of the build material thermal sensors is on a first side of the agent distribution device (FIG. 1, 104), i.e., the printheads (326), in a direction of carriage (102) transport while a second sub-array (534-2) of the build material thermal sensors is on a second side of the agent distribution device (FIG. 1, 104) in a direction of carriage transport.

That is, the carriage (102) may move in either direction indicated by the arrow (332) when depositing agent over the build material. Accordingly, by having sub-arrays (534) on either side of the printheads (326), then the thermal sensing system may be able to detect post-deposition thermal temperatures as the carriage (102) travels in either direction.

As an example, it may be that the agent deposition device (FIG. 1, 104) deposits agent as the carriage (102) moves to the right. In this example, the second sub-array (534-2) in front of the carriage (102) may not be able to provide a post agent-deposition temperature reading. In this example the first sub-array (534-1) may be used to provide the temperature measurements which are used to alter operation of the additive manufacturing system (100).

In another example, it may be that the agent deposition device (FIG. 1, 104) deposits agent as the carriage (102) moves to the left. In this example, the first sub-array (534-1) may not be able to provide a post agent-deposition temperature reading. In this example the second sub-array (534-2) may be used to provide the temperature measurements which are used to alter operation of the additive manufacturing system (100).

In yet another example, it may be that the agent deposition device (FIG. 1, 104) deposits agent in both directions. In this example, the second sub-array (534-2) and the first sub-array (534-1) may alternate passing measurements to the controller (108) based on which sub-array (534) is behind the agent deposition device (FIG. 1, 104) in the direction of carriage (102) travel.

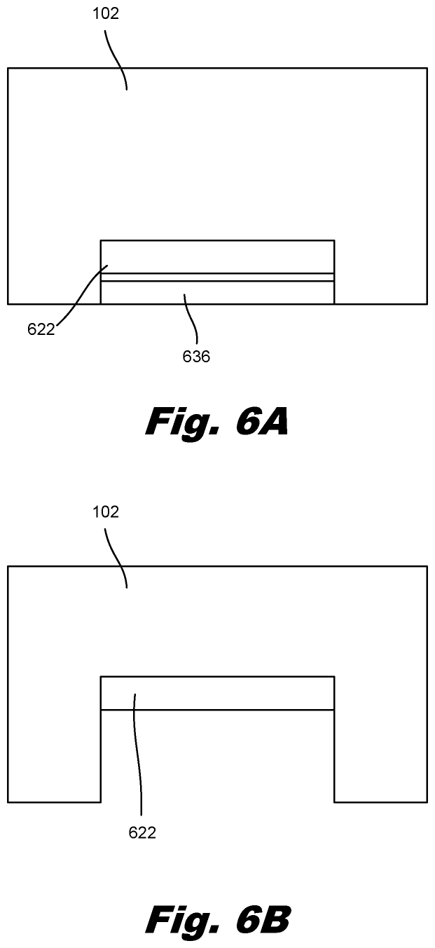

FIGS. 6A and 6B are diagrams of an optical filter (636) over a build material thermal sensor (622) that faces the build material, according to an example of the principles described herein. As depicted in earlier figures, it may that the build material thermal sensors (622) are disposed adjacent to heaters, which may be lamps, that irradiate onto the surface of the build material. The thermal sensors (622) themselves may capture this irradiation, which may skew a temperature measurement. Additionally, radiation emitted by the heaters may be undesirably reflected within the additive manufacturing system (FIG. 1, 100) and may impinge on the build material thermal sensor of the downward facing build material. Accordingly, irradiation leakage from the carriage heaters (FIG. 3, 320) may spill into the build material thermal sensors (622), which may skew the results of any temperature measurement.

In an example, this may be accounted for by including an optical filter (636) disposed in front of the array (FIG. 1, 106) of build material thermal sensors (622). In one example, an optical filter (636) is disposed in front of each build material thermal sensor (622). This example is depicted in FIG. 6A.

The optical filter (636) facilitates the capture of temperature measurements to within a particular bandwidth to reduce temperature measurement interference from heat sources, such as the carriage heater (FIG. 3, 320) and stationary overhead heater (FIG. 3, 318), in the additive manufacturing system (FIG. 1, 100). Specifically, the optical filter (636) may be a narrowband bypass filter in front of the build material thermal sensors (622). That is, the optical filter (636) may be placed in front of the build material thermal sensor (622) to block signals from the heating system components.

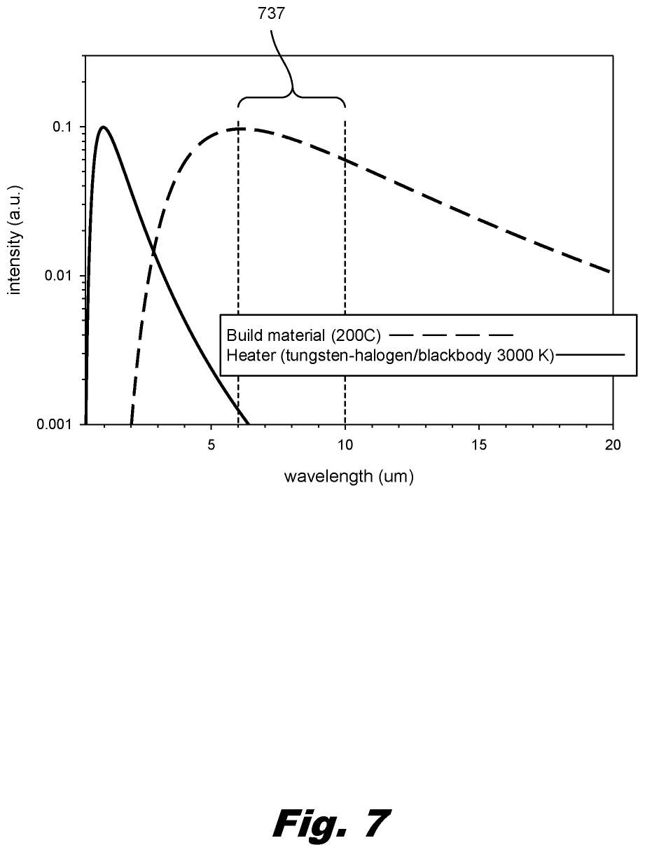

For example, as depicted in the graph of FIG. 7, a tungsten-halogen heater may generally emit in a range of 0-6 microns, with the intensity of irradiation tailing off past 6 microns. As such, the optical filter (636) may be a bandpass filter that has a sensor window (737), i.e., allows radiation, from 6 microns to 10 microns to pass to the build material thermal sensor (622). Accordingly, any irradiation received at the build material thermal sensor (622) may be unaffected by the irradiation from the heater lamps. That is, the optical filter (636) may cut off transmission at shorter wavelengths to eliminate irradiation from the tungsten-halogen lamps. In specific cases, bandpass range of the optical filter (636) may be selected to match the expected temperatures of the processed build material, and blackbody radiation model may be used to determine the bandpass range.

In another example, the controller (FIG. 1, 108) may account for the irradiation from the heaters (FIG. 3, 318, 320) without implementing an optical filter (636). While particular reference is made to an optical filter (636) with a particular filter range, the optical filter (636) may filter other ranges based on, for example, additive manufacturing geometry, spacing between the carriage (FIG. 1, 102) and the build materials surface, and optical properties of the build material.

In another example, this incident radiation may be accounted for by recessing the build material thermal sensors (622) within the carriage (102) surface as depicted in FIG. 6B. Doing so may reduce the number of interfering rays reaching the build material thermal sensor (622). In one particular example, both the built material thermal sensor (622) and the optical filter (636) may be recessed within the carriage (102) as depicted in FIG. 6B.

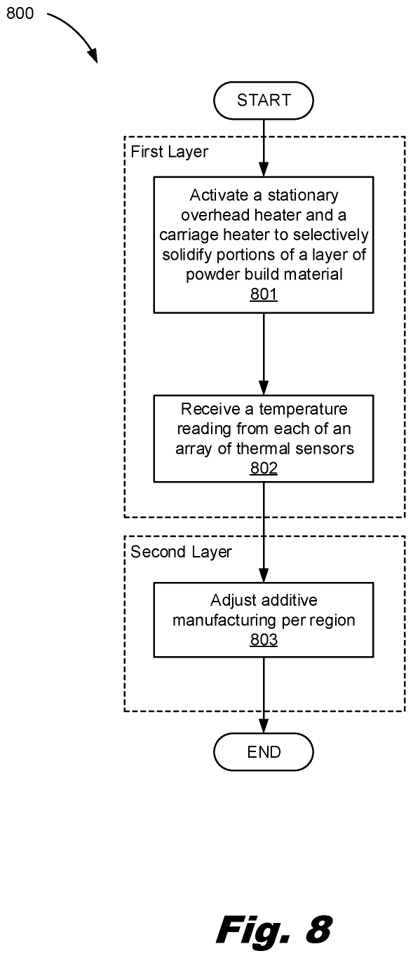

FIG. 8 is a flow chart of a method (800) for regionally adjusting additive manufacturing, according to an example of the principles described herein. That is, the method (800) illustrates how the temperature data measured by the build material thermal sensors (FIG. 6, 622) mounted on the downward facing side of the carriage (FIG. 1, 102) can be used to improve printing uniformity. As described above, measurements can be taken and adjustments determined during deposition of a first layer while adjustments are implemented in a second layer.

Specifically, while forming a first layer of a 3D object, the method (800) includes activating (block 801) a stationary overhead heater (FIG. 3, 318) and a carriage heater (FIG. 3, 320) to selectively solidify portions of a layer of powder build material. While this is being done, the controller (FIG. 1, 108) may be receiving (block 802) a temperature reading from each build material thermal sensor (FIG. 6, 622) of an array (FIG. 1, 106). As described above, there may be multiple measurements taken across the surface of the bed (FIG. 2, 212) by multiple build material thermal sensors (FIG. 6, 622). That is, rather than a single sensor measuring the temperature across the bed (FIG. 2, 212), multiple thermal sensors (FIG. 6, 622) may take measurements across the bed (FIG. 2, 212) resulting in a thermal map across the entire surface.

While forming the second layer of the 3D object, the controller (FIG. 1, 108) may adjust (block 803) additive manufacturing in different regions based on an output of a thermal sensor (FIG. 6, 622) in an associated region. That is, the controller (FIG. 1, 108) may take any number of remedial actions to account for build material that is outside of a desired thermal range either before, after or during agent deposition.

Such adjustments may include adjusting a radiation intensity of the heaters (FIG. 3, 318, 320) of the additive manufacturing system (FIG. 1, 100). For example, radiation intensity may be increased when the temperatures are cooler than desired, and radiation intensity may be decreased when the temperatures are warmer than desired. As described above, this may be done locally via the use of light emitting diode (LED) arrays as a heater may allow for adjusting the intensity of individual LEDs to account for observed non-uniform powder heating.

As another example, a quantity of an agent deposited during additive manufacturing may be adjusted. For example, more fusing agent or less detailing agent may be deposited when the temperatures are cooler than desired and less fusing agent or more detailing agent may be deposited when the temperatures are warmer than desired.

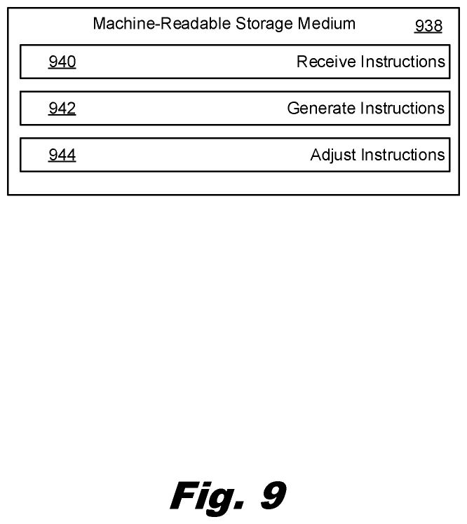

FIG. 9 depicts a non-transitory machine-readable storage medium (938) for regionally adjusting additive manufacturing, according to an example of the principles described herein. To achieve its desired functionality, a controller (FIG. 1, 108) includes various hardware components. Specifically, a controller (FIG. 1, 108) includes a processor and a machine-readable storage medium (938). The machine-readable storage medium (938) is communicatively coupled to the processor. The machine-readable storage medium (938) includes a number of instructions (940, 942, 944) for performing a designated function. The machine-readable storage medium (938) causes the processor to execute the designated function of the instructions (940, 942, 944). The machine-readable storage medium (938) can store data, programs, instructions, or any other machine-readable data that can be utilized to operate the additive manufacturing system (FIG. 1, 100). Machine-readable storage medium (938) can store computer readable instructions that the processor of the controller (FIG. 1, 108) can process, or execute. The machine-readable storage medium (938) can be an electronic, magnetic, optical, or other physical storage device that contains or stores executable instructions. Machine-readable storage medium (938) may be, for example, Random Access Memory (RAM), an Electrically Erasable Programmable Read-Only Memory (EEPROM), a storage device, an optical disc, etc. The machine-readable storage medium (938) may be a non-transitory machine-readable storage medium (938).

Referring to FIG. 9, receive instructions (940), when executed by the processor, cause the processor to, receive a temperature reading from an array (FIG. 1, 106) of build material thermal sensors (FIG. 6, 622) disposed on a carriage (FIG. 1, 102) of an additive manufacturing system (FIG. 1, 100). Each build material thermal sensor (FIG. 6, 622) of the array (FIG. 1, 106) faces a layer of powder build material and is to measure a temperature of the layer of powder build material in a particular region. Generate instructions (942), when executed by the processor, cause the processor to, generate a thermal map across a surface of the layer of powder build material. Adjust instructions (944), when executed by the processor, cause the processor to, adjust additive manufacturing in different regions based on an output of an associated build material thermal sensor (FIG. 6, 622).

Such systems and methods 1) print 3D objects with uniform and desired mechanical properties; 2) ensure accurate, consistent, and correct temperature measurements; and 3) provide temperature readings continuously through the additive manufacturing process. However, it is contemplated that the systems and methods disclosed herein may address other matters and deficiencies in a number of technical areas.

What is claimed is:

1. An additive manufacturing system, comprising:
an agent distribution device to selectively deposit an agent onto a layer of build material to form a layer of a three-dimensional (3D) object;
a carriage to transport the agent distribution device across the layer of build material;
an array of build material thermal sensors disposed on the carriage and facing the layer of build material, each build material thermal sensor to measure a temperature of the layer of build material in a particular region; and
a controller to adjust additive manufacturing in different regions based on an output of an associated build material thermal sensor.

2. The additive manufacturing system of claim 1, wherein adjusting additive manufacturing is performed per layer of build material.

3. The additive manufacturing system of claim 1:
further comprising a heating system to selectively heat the layer of powder build material; and
wherein the controller is to adjust individual heating elements of the heating system based on an output of a build material thermal sensor in an associated region.

4. The additive manufacturing system of claim 1, wherein:
the heating system comprises:
a carriage heater to selectively solidify portions of the layer of powder build material with agent deposited thereon; and
a stationary overhead heater to maintain the layer of powder build material at a predetermined temperature below a solidifying temperature of the agent.

5. The additive manufacturing system of claim 1, wherein:
the array of build material thermal sensors is divided into a first sub-array and a second sub-array.

6. The additive manufacturing system of claim 5, wherein:
a first sub-array is on a first side of the agent distribution device in a direction of carriage transport; and
a second sub-array is on a second side of the agent distribution device in the direction of carriage transport.

7. The additive manufacturing system of claim 1, further comprising a carriage thermal sensor embedded in the carriage to sense a carriage temperature, wherein the temperature measurements of the build material thermal sensors are offset by a temperature measurement of the carriage thermal sensor.

8. The additive manufacturing system of claim 1, further comprising an optical filter disposed in front of the array of build material thermal sensors to collect temperature measurements in a particular bandwidth to reduce temperature measurement interference from heat sources in the additive manufacturing system.

9. The additive manufacturing system of claim 8, wherein an optical filter is disposed in front of each build material thermal sensor.

10. The additive manufacturing system of claim 1, further comprising a cooling system to prevent overheating of the array of build material thermal sensors.

11. A method, comprising:
while forming a first layer of a three-dimensional (3D) object:
activating a stationary overhead heater and a carriage heater of an additive manufacturing system as a carriage passes over a layer of powder build material to selectively solidify portions of the layer of powder build material; and
receiving a temperature reading from an array of build material thermal sensors disposed on the carriage and facing the layer of powder build material, wherein each build material thermal sensor is to measure a temperature of the layer of build material in a particular region; and
while forming a second layer of the 3D object, adjusting additive manufacturing in different regions based on an output of an associated build material thermal sensor.

12. The method of claim 11, wherein adjusting additive manufacturing comprises adjusting a radiation intensity of heaters of the additive manufacturing system.

13. The method of claim 11, further comprising adjusting a quantity of an agent deposited during additive manufacturing.

14. A non-transitory machine-readable storage medium encoded with instructions executable by a processor, the machine-readable storage medium comprising instructions to:
receive a temperature reading from each of an array of build material thermal sensors disposed on a carriage of an additive manufacturing system, wherein each build material thermal sensor faces a layer of powder build material and is to measure a temperature in a particular region;
generate a thermal map across a surface of the layer of powder build material; and
adjust additive manufacturing in different regions based on an output of an associated build material thermal sensor.

15. The non-transitory machine-readable storage medium of claim 14, wherein adjusting additive manufacturing comprises adjusting components associated with different regions of the thermal map differently.
